(19) United States
(12) Patent Application Publication
(10) Pub. No.: US 2015/0176539 A1
(43) Pub. Date: Jun. 25, 2015

(54) ENGINE-CONTROL VALVE WITH IMPROVED OPERATION

(71) Applicant: Valeo Systemes de Controle Moteur, Cergy Saint Christophe (FR)

(72) Inventor: Grégory Hodebourg, Sartrouville (FR)

(21) Appl. No.: 14/415,745

(22) PCT Filed: Jul. 25, 2013
(86) PCT No.: PCT/FR2013/051803

§ 371 Date: Jan. 20, 2015

(30) Foreign Application Priority Data
Jul. 26, 2012 (FR) 1257251

(51) Int. Cl. F02M 25/07

(52) U.S. Cl. CPC F02M 25/0793

(57) ABSTRACT

The invention relates to an engine-control valve having a body defining an inner channel and including a flap (10) pivotably mounted by a pin (12), said flap (10) including a first portion (11) and being capable of pivoting between an open position enabling gas to flow into the channel, and a closed position preventing said flow, and in which the flap (10) engages with a planar seal (1) inserted between two elements of the valve body, said seal (1) having an outer contour surrounding the outer contour of the flap (10) on the outside and said seal including an opening (6) and a solid portion (3), said first portion (11) blocking the opening (6) of the seal (1) when the flap (10) is in a closed position, one of the two elements (20) of the body being provided with a supporting projection (21), positioned in the valve such as to be in contact with the solid portion (3) of the seal (1).

The invention relates to an engine control valve having improved operation. This type of valve may for example be fitted in a gas supply circuit of a vehicle combustion engine, in order to regulate the flow rate of the EGR (Exhaust Gas Recirculation) gases in a loop making it possible to bleed a part of the exhaust gases leaving the engine so as to reinject them upstream of said engine. The operating principle of this type of valve is based on the controlled rotation of a flap which can move from a completely open position for allowing gases to pass through to a closed position for blocking this passage. The subject of the invention is an engine control valve having improved operation.

An engine control valve thus has a flap which is mounted in a pivoting manner on a rotary pin. Said pin can separate the flap into a first part and a second part. When this flap is in a closed position, it comes into contact with a gasket that is secured to the body of the valve, said gasket sealing the valve by acting as a positioning end stop for said flap. More specifically, the gasket is flat overall and is fastened in the body of the valve by being inserted at its perimeter between two elements of said body. These elements are for example cast elements. The gasket has an opening, and when the flap is in the closed position, the first part of the flap comes into contact with one of the two faces of the gasket in order to close off said opening, while the second part of said flap is flush with the other face of said gasket. The flap has a small thickness and has a substantially rectangular overall shape.

At first, for reasons associated with its manufacture, the gasket only covered three of the four peripheral edges of said flap, leaving a potential passage for the gases at the fourth edge of the flap, which is not covered by said gasket. Thus, when the flap is in the closed position against the gasket, said passage is likely to favor an accidental leak of the gases. This results in fairly mediocre sealing of said valve in the closed configuration.

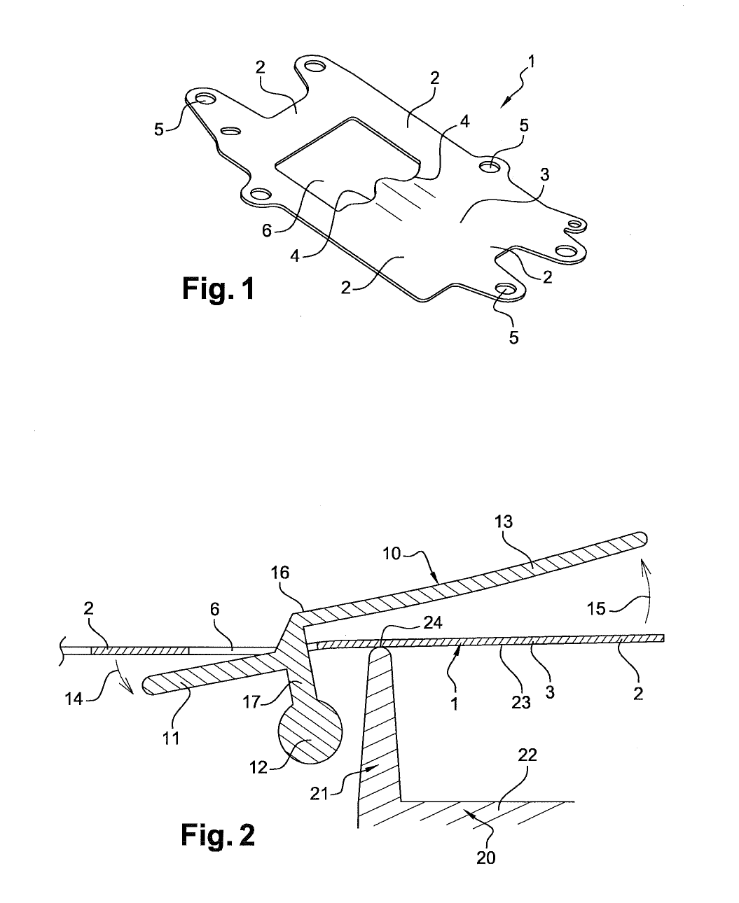

Then, a solution for remedying this poor-quality sealing consisted in the manufacture of a gasket either in one part or in two parts, the gasket being sufficiently extensive to fully cover the four peripheral edges of the flap and thus to limit the sources of leaks. However, with reference to FIG. 1, a problem that is regularly encountered with this type of extensive gasket 1 is that it is subjected both to a high pressure and to a high temperature by the gases present in the valve and it thus tends to deform under the effect of thermal expansion. Since said gasket is inserted at its outer edge 2 between two cast elements, the deformation will essentially occur in the central part 3 of the gasket 1, creating hollows 4 and/or bosses which are likely to form leakage passages for the gases located in the valve. Moreover, in the case where the gasket 1 deforms and creates hollows 4, it risks forming an artificial blocking stop for the flap, and thus impeding the pivoting thereof in order to come into contact with said gasket 1 in order to close the valve. In other words, the deformation of the gasket risks impeding the operating mechanism of the valve.

The subject of the invention, according to one of its aspects, is an engine control valve having a body that delimits an internal duct and comprising a flap mounted in a pivoting manner by way of a pin, said flap comprising a first part and being able to pivot between an open position allowing gas to pass through the duct and a closed position preventing this passage and in which the flap comes into contact with a gasket, notably a flat gasket, inserted between two elements of the body of the valve, said gasket having an external contour that externally surrounds the external contour of the flap and said gasket comprising an opening and a solid portion, said first part closing off the opening in the gasket when the flap is in a closed position,

one of the two elements of the body being provided with a supporting protuberance that is positioned in the valve so as to be in contact with the solid portion of the gasket.

An engine control valve according to the invention employs an extensive gasket that entirely covers the flap, and a body shaped to prevent the gasket from deforming under the effect of a high temperature and a high pressure of the gases. In this way, an engine control valve according to the invention will operate satisfactorily regardless of the temperature and the pressure of the gases flowing through said valve, without risking having its flap prevented from rotating under the effect of the deformation of the gasket.

Specifically, under the effect of the presence of hot gases in the valve, the gasket is likely to deform by thermal expansion and can thus create leakage passages for said gases when the valve is closed, and can also prevent the flap from rotating, The supporting protuberance is preferably configured to come into contact with the most vulnerable part of the gasket, which is subjected most to deformation, in order to keep said part in a satisfactory flat state. The protuberance advantageously takes up little space in order not to make the valve heavier or to reduce the flow cross sections for the gases in said valve. This protuberance can act as a prop for supporting the gasket, said prop being configured not to have any interaction or influence in the valve. A priori, this protuberance forms a part protruding from the element of the body and can have any shape. This protuberance may be formed from the same material as that of the element of the body, the latter being notably cast, or be formed from a different material. Similarly, this protuberance may be an added part which has been secured to the element of the body, or may form with said element one and the same part manufactured in one operation.

Advantageously, the gasket is inserted between the two elements, notably cast elements, at a peripheral region of said gasket. This type of fastening is conventional since it allows the central part of the gasket, which is formed by the solid portion and by the opening, to interact with the flap in order to provide proper sealing of the valve in its closed position. However, it causes the drawback of making this central part structurally weak, since it is not supported and is likely to deform by thermal expansion. The presence of the protuberance is thus particularly suitable for this mounting configuration.

Preferably, the supporting protuberance protrudes from the element of the body so as to be perpendicular to the plane defined by the solid portion of the gasket. This is an optimal configuration in which the action of the protuberance on the solid portion of the gasket is most effective, since it does not favor any particular deformation direction.

The protuberance can protrude from a part of the element of the body that defines a part of the duct, for example from a wall of the duct.

The protuberance may be made in one piece with an element of the body, a part of which defines all or part of the duct and another part of which defines all or part of the external surface of the body. A one-piece part can thus define all or part of the external surface of the body of the valve, all or part of the wall of the duct, and the protuberance.

Advantageously, the supporting protuberance extends parallel to the rotary pin of the flap. Specifically, the function of retaining the protuberance on the solid portion of the gasket must be particularly pronounced in a direction parallel to the rotary pin, while it is not necessary for this function to extend in a direction perpendicular to said pin. The protuberance may consist of a single part, made in one block, or consist of at least two separate parts that are aligned along the rotary pin.

Advantageously, the protuberance extends along a length of between 50% and 100% of the total length of the rotary pin. Specifically, it is not necessary for the protuberance to extend along the entire length of the pin in order to be effective. The length of this protuberance will be determined by the geometry of the body of the valve, the dimensions and shape of the gasket, and the level of stress brought about by the hot gases, in terms of pressure and temperature.

Preferably, the region of the solid portion of the gasket which is in contact with the supporting protuberance is a region which borders the opening in said gasket. Specifically, this specific region of the gasket is most likely to deform and thus needs to be supported homogeneously in order to stay properly flat.

Preferably, the solid portion of the gasket is provided with a reinforcing region intended to stiffen said portion such that it does not deform by thermal expansion. Specifically, besides the action of the supporting protuberance, it may be desirable to reduce the risks of deformation of the solid portion of the gasket by implementing a reinforcement of said portion. This reinforcing region may be formed for example by a relief produced by stamping the solid portion of the gasket, or by addition of material such as a thin metal strip. The relief may have a small extent and be similar, for example, to a reinforcement rib.

Advantageously, the end of the supporting protuberance which is in contact with the solid portion of the gasket is flat. In this way, the area of contact between the protuberance and the solid portion of the gasket is spread out, making it possible to increase the quality of contact between these two elements and thus increasing the effectiveness of the support of said protuberance with respect to said solid portion.

Advantageously, the protuberance comes into contact with the solid portion of the gasket without causing any deformation of said portion. Specifically, even though the contact between the solid portion and the protuberance has to be effective, it must take place to a particular extent in order not to cause any deformation of the solid portion of the gasket, which could then impede the operation of the valve and worsen the conditions of contact between the second part of the flap and said solid portion, when the flap is in two parts, as mentioned below.

A valve according to the invention has the advantage of being effective in terms of operation, preventing the deformation of the gasket in a simple and appropriate manner without notably requiring a fundamental redesign of its body. Said valve moreover has the advantage of remaining at a constant size with respect to pre-existing valves, since the supporting protuberance takes up space already available in the valve. A valve according to the invention also has the advantage of having a degree of modularity, since the supporting protuberance can have a multiplicity of different sizes and geometries, depending on the internal design of said valves, on the design of the gasket, and also on the degree of stress which could be brought about by the gases present in these valves.

The flap may comprise a second part that is separated from the first part by the pin of the flap, said second part being flush with the solid portion when the flap is in a closed position.

Preferably, the contact between the supporting protuberance and the solid portion of the gasket is made at that face of the gasket that is opposite the one with which the second part of the flap is flush when said flap is in a closed position.

The invention may be better understood on reading the following description of a nonlimiting exemplary embodiment thereof and on studying the appended drawing, in which:

FIG. 1 is a line drawing of a deformed prior art gasket,

FIG. 2 is a schematic cross-sectional view of a gasket, a flap and a supporting protuberance for a valve according to one exemplary embodiment of the invention, said flap being in an open position.

An engine control valve according to the invention can be for example an EGR (Exhaust Gas Recirculation) valve that regulates the flow rate of the gases through a loop connecting an exhaust circuit to an air intake circuit of a vehicle combustion engine.

With reference to FIG. 1, a prior art gasket 1 is made of rigid stainless steel and is inserted at its peripheral region 2 between two elements 20 of the body of the valve. These elements 20 are for example cast elements 20 and they may be made of aluminum, cast iron or stainless steel. This peripheral region 2 thus has a number of orifices 5 that are intended to be passed through by screws so to fasten the gasket 1 between said cast elements 20. This gasket 1 is flat, having a substantially rectangular shape with a small thickness, and has a solid portion 3 and a passage opening 6 for the gases, said portion 3 and said opening 6 forming the central part of said gasket 1.

With reference to FIG. 2, a valve according to one exemplary embodiment of the invention comprises an internal duct and functions with a flap 10 that is rotationally mobile between a completely open position, in which it allows the gases to pass through the duct at a maximum flow rate, and a closed position in which it closes off said duct entirely. The flap 10 is rectangular overall and in the example in question has a first rectangular part 11 and a second rectangular part 13 which are located on either side of a rotary pin 12, said parts 11,13 being flat, in continuity of one another, and being fastened rigidly together.

More precisely, the first part 10 and the second part 13 are joined together at an interface plane 16, said flap 10 being provided with a lever arm 17 that starts at said interface plane 16 and is ended by the rotary pin 12. This lever arm 17 is approximately perpendicular to the plane of the flap 10 formed by the first 11 and second 13 parts. Preferably, the flap 10 is made of stainless steel.

The flap 10 in the example described is mounted so as to rotate in the valve such that in the closed position, the first part 11 of the flap 10 closes off the opening 6 by coming into contact with one face of said gasket 1, and such that the second part 13 of the flap 10 is flush with the opposite face of said gasket 1 in the region of the solid portion 3. The rotary pin 12 of the flap 10 is positioned perpendicularly to the opening 6 in the gasket 1 in the region of said opening 6 that is closest to the solid region 3 of the gasket 1.

When the flap 10 opens to allow the gases to pass through, the two parts 11, 13 pivot simultaneously in the direction indicated by the two arrows 14, 15 so as to move away from the face of the gasket 1 against which they were bearing or flush. In this configuration, the first part 11 of the flap 10 opens the opening 6 in the gasket 1 so as to allow the gases to flow through the duct. It should be noted that the rotation of the flap 10 is controlled and that said flap can be fixed in a multiplicity of intermediate positions between the closed position and the completely open position.

With reference to FIG. 1, the gasket 1 of a valve according to the described exemplary embodiment of the invention is made in one piece and has such an extent as to be able to cover the four peripheral edges of the flap 10. When this gasket 1 is not supported, it has a structurally weak central region which is likely to deform under the combined effect of the high pressure and high temperature of the gases. Specifically, since the gasket 1 is fastened at its periphery 2, only its central part, the movement of which is not restricted, can be subjected to the effects of thermal expansion. This deformation can cause the gasket 1 to warp, creating hollows 4 in the solid part 3 bordering the opening 6. However, a deformed gasket 1 having hollows 4 can impede the rotary mechanism of the flap 10 in the valve, by bearing against the lever arm 17 of said flap 10 and thus preventing the rotation thereof.

With reference to FIG. 2, one of the two elements 20, in this case cast elements, of the body of the valve makes it possible to prevent deformation of this gasket 1 by being provided with a supporting protuberance 21 which is dimensioned to come into contact with the solid portion 3 of the gasket 1. This protuberance 21 starts at a base 22 of the cast element 20 and protrudes from said base 22 in a direction which allows said protuberance 21 to be perpendicular to the surface plane of the solid portion 3 of the gasket 1. The end 24 of the protuberance 21, which comes into contact with the solid portion 3 of the gasket 1, is flat in the example considered, so as to bring about flat contact with said solid portion 3. This contact is made at that face 23 of the gasket 1 that is opposite the one with which the second part 13 of the flap 10 is flush when said flap 10 is in a closed position. This protuberance 21 has notably a rectangular parallelepipedal shape, the longitudinal axis of which is parallel to the rotary pin 12 of the flap 10.

The length of this protuberance is for example equal to 75% of the total length of the rotary pin 12, said protuberance being positioned centrally with respect to said rotary pin 12. This supporting protuberance 21 comes into contact with the solid portion 3 of the gasket 1, which borders the opening 6, and the contact interface between said protuberance 21 and said solid portion 3 is located somewhat set back from the end of said portion 3 which delimits said opening 6. Said protuberance 21 ensures contact with the gasket 1 without causing the least deformation of the solid portion 3 of said gasket, leaving the gasket 1 in a perfectly flat state. The protuberance 21 preferably has the right dimensions to be able to carry out its function of effectively supporting the gasket 1 but without impeding the rotation of the flap 10 or influencing the passage of the gases through the valve. Similarly, this protuberance 21 advantageously should not contribute to significantly increasing the weight of the valve.

According to another exemplary embodiment (not shown) of the invention, the solid portion 3 of the gasket 1 may be provided with a reinforcing region that complements the supporting protuberance 21 so as to prevent the gasket 1 from deforming by thermal expansion, as described in the French patent filed by the Applicant on 4 Jul. 2012 under the number 12 56390 and the content of which is incorporated by reference in the present application.

Specifically, the protuberance 21 prevents the gasket 1 from deforming in one direction and the reinforcing region limits, or eliminates, the deformation of said gasket 1 in the other direction. This reinforcing region may consist of an addition of material, for example in the form of a very thin metal strip which would be welded to the solid portion 3 of the gasket 1. It may also consist of a relief on the solid portion 3 of the gasket 1, made by stamping, this relief preferably being able to be similar to a rib.

The added metal strip or the rib extends notably parallel to the rotary pin 12 of the flap 10 and is located at the solid portion 3 of the gasket bordering the opening 6. The contact interface between the supporting protuberance 21 and the solid portion 3 of the gasket 1 may overlap, at least partially, the reinforcing region, formed by the added metal strip or the rib, of said gasket 1.

1. An engine control valve having a body that delimits an internal duct and comprising:
a flap mounted in a pivoting manner by way of a pin, said flap comprising a first part and being able to pivot between an open position allowing gas to pass through the duct and a closed position preventing this passage and in which the flap comes into contact with a gasket inserted between two elements of the body of the valve,
said gasket having an external contour that externally surrounds the external contour of the flap and said gasket comprising an opening and a solid portion, said first part closing off the opening in the gasket when the flap is in a closed position,
one of the two elements of the body being provided with a supporting protuberance that is positioned in the valve so as to be in contact with the solid portion of the gasket,
the flap comprising a second part that is separated from the first part by the pin of the flap, said second part being flush with the solid portion when the flap is in a closed position.

2. The valve as claimed in claim 1, wherein the gasket is inserted between the two elements of the body at a peripheral region of said gasket.

3. The valve as claimed in claim 1, wherein the supporting protuberance protrudes from the element of the body so as to be perpendicular to the plane defined by the solid portion of the gasket.

4. The valve as claimed in claim 1, wherein the supporting protuberance extends parallel to the rotary pin of the flap.

5. The valve as claimed in claim 4, wherein the protuberance extends along a length of between 50% and 100% of the total length of the rotary pin.

6. The valve as claimed in claim 1, wherein the region of the solid portion of the gasket which is in contact with the supporting protuberance is a region which borders the opening in said gasket.

7. The valve as claimed in claim 1, wherein the solid portion of the gasket is provided with a reinforcing region intended to stiffen said portion such that it does not deform by thermal expansion.

8. The valve as claimed in claim 1, wherein the end of the supporting protuberance which is in contact with the solid portion of the gasket is flat.

9. The valve as claimed in claim 1, wherein the protuberance comes into contact with the solid portion of the gasket without causing any deformation of said portion.

10. The valve as claimed in claim 1, wherein the contact between the supporting protuberance and the solid portion of the gasket is made at that face of the gasket that is opposite the one with which the second part of the flap is flush when said flap is in a closed position.

11. The valve as claimed in claim 1, wherein the protuberance is made in one piece with said element of the body, a part of this element defining a part of the duct and another part of this element defining a part of the external surface of the body.
